(19) United States
(12) Patent Application Publication
(10) Pub. No.: US 2017/0024405 A1
(43) Pub. Date: Jan. 26, 2017

(54) METHOD FOR AUTOMATICALLY GENERATING DYNAMIC INDEX FOR CONTENT DISPLAYED ON ELECTRONIC DEVICE

(71) Applicant: Samsung Electronics Co., Ltd., Suwon-si (KR)

(72) Inventors: Sailesh Kumar SATHISH, Bangalore (IN); Manish KUMAR, Bangalore (IN)

(21) Appl. No.: 15/217,287

(22) Filed: Jul. 22, 2016

(30) Foreign Application Priority Data
Jul. 24, 2015 (IN) 3820/CHE/2015

(51) Int. Cl. G06F 17/30

(52) U.S. Cl. CPC G06F 17/3089; G06F 17/30321; G06F 17/30958

(57) ABSTRACT

A method for automatically generating a dynamic index for content displayed on an electronic device is provided. The method includes detecting the content displayed on the electronic device, generating, by the processor, the dynamic index for the content based on user intent, and causing to display the dynamic index on a screen of the electronic device.

### CROSS-REFERENCE TO RELATED APPLICATION(S)

This application claims the benefit under 35 U.S.C. §119(a) of an Indian provisional patent application filed on Jul. 24, 2015 in the Indian Intellectual Property Office and assigned Serial number 3820/CHE/2015, and of an Indian non-provisional patent application filed on Mar. 1, 2016 in the Indian Intellectual Property Office and assigned Serial number 3820/CHE/2015, the entire disclosure of each of which is hereby incorporated by reference.

### TECHNICAL FIELD

The present disclosure relates to electronic devices. More particularly, the present disclosure relates to a mechanism for automatically generating a dynamic index for content displayed on an electronic device.

### BACKGROUND

World Wide Web is the most commonly used information retrieval system. One of the distinguishing features of documents (or E-books) on the World Wide Web is the use of hypertext links which allow a user to navigate from one section of the document to other section of the document by activation of the link.

In the systems and methods of the related art, content, such as the E-books, one or more web pages, linked documents, videos, and the like, have static links. The static links point to sections manually segregated by author(s). These sections do not provide specificity on the chapters and take user interests to define the links to the sections. In an example, when the user accesses the document, the links are provided to the user as defined by the author.

Therefore, a need exists for a mechanism for automatically generating a dynamic index for content displayed on an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mechanism for automatically generating a dynamic index for content displayed on an electronic device.

The principal object of the embodiments herein is to provide a mechanism for automatically generating a dynamic index for content displayed on an electronic device.

Another object of the embodiments herein is to provide a mechanism for detecting, by a processor in the electronic device, the content displayed on the electronic device.

Another object of the embodiments herein is to provide a mechanism for generating, by the processor, the dynamic index for the content based on user intent.

Another object of the embodiments herein is to provide a mechanism for causing, by the processor, to display the dynamic index on a screen of the electronic device.

In accordance with an aspect of the present disclosure, a method for automatically generating a dynamic index for content displayed on an electronic device is provided. The method includes detecting, by a processor in the electronic device, the content displayed on the electronic device, generating, by the processor, the dynamic index for the content based on user intent, and causing, by the processor, to display the dynamic index on a screen of the electronic device.

In accordance with another aspect of the present disclosure, an electronic device for automatically generating a dynamic index for content is provided. The electronic device includes a memory and a processor coupled to the memory. The processor is configured to detect the content displayed on the electronic device. Further, the processor is configured to generate the dynamic index for the content based on user intent. Further, the processor is configured to cause to display the dynamic index on a screen of the electronic device.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

Other aspects, advantages, and salient features of the disclosure will become apparent to those skilled in the art from the following detailed description, taken in conjunction with the annexed drawings, discloses various embodiments of the present disclosure.

### BRIEF DESCRIPTION OF FIGURES

The above and other aspects, features, and advantages of certain embodiments of the present disclosure will be more apparent from the following description taken in conjunction with the accompanying drawings, in which:

FIG. 1 illustrates various units of an electronic device for automatically generating a dynamic index for content according to an embodiment of the present disclosure;

FIG. 2 illustrates various units of a processor for automatically generating a dynamic index for a content displayed on an electronic device according to an embodiment of the present disclosure;

FIG. 3 is a flow diagram illustrating a method for automatically generating a dynamic index for a content displayed on an electronic device according to an embodiment of the present disclosure;

FIG. 4 illustrates a framework architecture for generating a dynamic index within a content according to the embodiments of the present disclosure;

FIG. 5 illustrates a client—server architecture for automatically generating a dynamic index for a content according to an embodiment as of the present disclosure;

FIG. 6A is a sequence diagram for building a profile of a user and calculating user interest according to an embodiment of the present disclosure;

FIG. 6B is a sequence diagram for calculating a first level index and a second level index according to an embodiment of the present disclosure;

FIG. 7 is a sequence diagram for automatically generating a dynamic index for a content, by a server, according to an embodiment as of the present disclosure;

FIGS. 8A-8C illustrate an operation of generating a dynamic index for a content displayed on an electronic device according to an embodiment of the present disclosure;

FIG. 9 illustrates an operation of displaying a next level of dynamic index based on a swipe out gesture performed by a user on the dynamic index according to an embodiment of the present disclosure;

FIG. 10 illustrates an operation of displaying a dynamic index of an external content and an internal content on an electronic device according to an embodiment of the present disclosure;

FIG. 11 illustrates an operation of automatically generating a dynamic index for a content displayed on an electronic device according to an embodiment of the present disclosure;

FIG. 12 illustrates a comparison between a standard index and a dynamic index according to an embodiment of the present disclosure; and

FIG. 13 illustrates a computing environment implementing a method and a system for automatically generating a dynamic index for a content displayed on an electronic device according to embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The embodiments herein disclose a method for automatically generating a dynamic index for content displayed on an electronic device. The method includes detecting the content displayed on the electronic device. Further, the method includes generating the dynamic index for the content based on user intent. Further, the method includes causing to display the dynamic index on a screen of the electronic device.

In an embodiment of the present disclosure, the user intent includes at least of a user knowledge graph, a heuristics of the user reading pattern, a document type, topics of the content displayed on the electronic device, a state transition matrix, and user activities.

In an embodiment of the present disclosure, the state transition matrix includes entries corresponding to the topics within the content, where each of the entries represents a transition probability of transition from a current topic to a next topic.

In an embodiment of the present disclosure, the dynamic index includes a plurality of topics identified within the content, where the topics are dynamically arranged based on the user intent.

In an embodiment of the present disclosure, the plurality of topics includes a main topic and a subtopic, where the main topic is associated with at least one of an internal content source and an optional external content source, where the subtopic is associated with at least one of an internal content source and an optional external content source.

In an embodiment of the present disclosure, the dynamic index is used to generate at least one of a speech grammar from topics of the dynamic index for multi-modal set, a description corresponding to a topic in the dynamic index, and cross-language terms for a topic of the dynamic index.

Unlike the systems and methods of the related art, the proposed mechanism generates the dynamic index to the content which is created based on the user intent (or user interests), browsing pattern of the user, and bookmarks. In an example, for E-books, one or more web pages, one or more emails, one or more documents, videos, images, and the like, the dynamic index can be generated based on the user intent. In another example, links to optional external content sources are provided to the user if proper topics (or sections) are not detected within the E-book or if sources exist externally that can complement current indexed content. Further, the generated dynamic index is indicated via an intuitive user experience (UX).

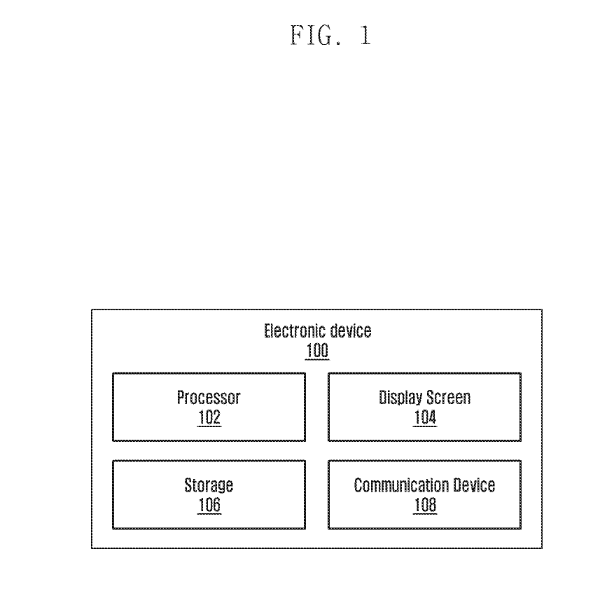

Referring now to the drawings, and more particularly to FIGS. 1 through 13, where similar reference characters denote corresponding features consistently throughout the figures, there are shown preferred embodiments.

FIG. 1 illustrates various units of an electronic device for automatically generating a dynamic index for content according to an embodiment of the present disclosure.

Referring to FIG. 1, an electronic device 100 can be, for example and not limited to a laptop, a desktop computer, a mobile phone, a smart phone, personal digital assistants (PDAs), a tablet, a phablet, a consumer electronic device, or any other electronic device.

In an embodiment of the present disclosure, the electronic device 100 includes a processor 102, a display screen 104, a storage 106, and a communication device 108.

Initially, a user loads the content (e-book) or a web page for automatically generating the dynamic index for the loaded content. The processor 102 can be configured to detect the content displayed on the display screen 104 of the electronic device 100. Further, the processor 102 can be configured to generate the dynamic index for the content based on user intent. In an embodiment of the present disclosure, the user intent includes a user knowledge graph, heuristics of the user reading pattern, a document type, topics of the content displayed on the electronic device 100, a state transition matrix, user activities, or combination of same. The state transition matrix includes entries corresponding to the topics within the content, where each of the entries represent a transition probability from a current topic to a next topic.

In an embodiment of the present disclosure, the dynamic index includes a plurality of topics identified within the content, where the topics are dynamically arranged based on the user intent. The plurality of topics includes a main topic and a subtopic, where the main topic is associated with at least one of an internal content source and an external content source, and the subtopic is associated with at least one of an internal content source and an optional external content source (i.e., an external content source). In an embodiment of the present disclosure, the dynamic index is used to generate at least one of a speech grammar from topics of the dynamic index for multi-modal set, a description corresponding to a topic in the dynamic index, and cross-language terms for a topic of the dynamic index. Further, the processor 102 can be configured to cause to display the dynamic index on the display screen 104 (i.e., a screen of the electronic device 100). The display screen 104 receives the generated dynamic index from the processor 102. Further, the display screen 104 displays the dynamic index.

Further, the storage 106 can be configured to store the state transition matrix including the entries corresponding to the topics within the content, where each of the entries represents the transition probability from the current topic to the next topic. The storage 106 may include one or more computer-readable storage media. The storage 106 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage 106 may, in some examples, be considered a non-transitory storage medium. The term “non-transitory” may indicate that the storage medium is not embodied in a carrier wave or a propagated signal. However, the term “non-transitory” should not be interpreted that the storage 106 is non-movable. In some examples, the storage 106 can be configured to store larger amounts of information than the memory. In certain examples, a non-transitory storage medium may store data that can, over time, change (e.g., in random access memory (RAM) or cache). The communication device can be configured for communicating internally between the devices and externally with the networks.

In an example, the dynamic index is generated for the user consumed content, such as the E-books, the web pages, the emails, the user documents, the videos, the images, and the like. Initially, the dynamic index is calculated based on the user intent and later corresponding dynamic index(s) are generated based on user clicks by maintaining the state transition matrix internally within the electronic device 100 or a server. Further, the proposed mechanism extracts the dynamic speech grammar from the topics for speech based navigation within the content. Further, the proposed mechanism provides topics from the optional external content sources in addition to the topics from the internal content sources based on the content availability.

Unlike the systems and methods of the related art, the proposed mechanism allows generating the dynamic intelligent links within the content. In the proposed mechanism, the dynamic intelligent links are generated based on the user interest. The generated dynamic intelligent links are indicated via intuitive UX. In an example, in case of E-book(s), web page(s), email(s), documents, video(s), image(s), and the like, the dynamic index can be generated automatically based on the user intent (i.e., a user interest). In another example, if proper sections are not available within the content displayed on the electronic device 100, dynamic index is generated providing links to external sources.

Unlike the systems of the related art, the proposed mechanism improves the UX by providing the dynamic index, Sub-sections index, Pause and resume functionality, topics from external sources. Further, the proposed mechanism gathers the user data from the E-readers and the dynamic index is shared with applications.

Referring to FIG. 1 shows a limited overview of the electronic device 100 but, it is to be understood that other embodiment is not limited thereto. Further, the electronic device 100 can include any number of devices communicating among each other.

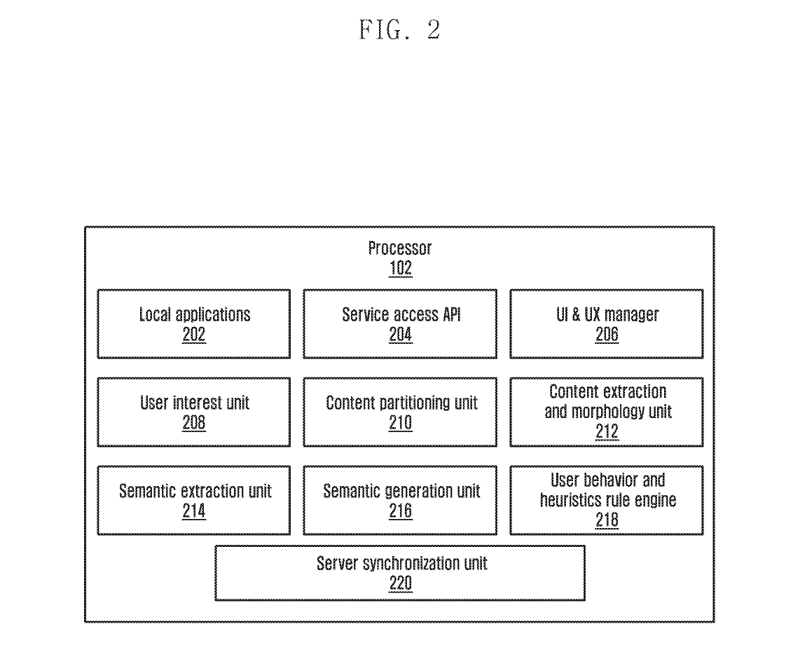

FIG. 2 illustrates various units of a processor for automatically generating a dynamic index for a content displayed on an electronic device according to an embodiment of the present disclosure.

Referring to FIG. 2, in an embodiment of the present disclosure, the processor 102 includes local applications 202, a service access application programming interface (API) 204, an UI and UX manager 206, an User interest unit 208, a content partitioning unit 210, a content extraction and morphology unit 212, a semantic extraction unit 214, a semantic generation section unit 216, a user behavior and heuristics rule unit 218, and a synchronization unit 220.

The content extraction and morphology unit 212 extracts and pre-filters the content provided by the local applications 202. Further, the content extraction and morphology unit 212 removes redundant meta-content, such as formatting data and provides pure text to the semantic extraction unit 214. After receiving the text from the content extraction and morphology unit 212, the semantic extraction unit 214 extracts the content semantics for each section or page of the text and builds appropriate semantic signatures per section. The user interest unit 208 builds a user interest profile based on users past behavior with the content. The user behavior and heuristics rule engine 218 is an adaptive system that has pre-loaded rule behaviors on how to partition the content as well as being able to adjust rule sets dependent on the user behavior.

Further, the semantic generation unit 216 extracts the rule sets from the user behavior and heuristics rule engine 218 and performs mapping with the semantics extracted by the semantic extraction unit 214. The content partitioning unit 210 performs final partitioning of the content including building the sections and subsections taking into account the user preferences as inferred through the user interest unit 208. The UI and UX manager 206 performs the UI part including rendering the index computed. Local applications interface with the service through the service access API 204. The server based synchronization for the external content and user account management, if any, happens through the synchronization unit 220.

In an example, the processor 102 detects a document set including single or multiple pages, the set of videos, the set of images, or combinations of same from the user. After receiving the document set, the processor 102 continuously provides links to the topics within the content where the topics are dynamically generated based on the user intent. Further, the processor 102 computes the number of interest topics within the content and continuously re-computes the dynamic index including the topics displayed to the user based on the state transition matrix, where the transition matrix represents the topic within the content and each entry of the state transition matrix represents the transition probability for the user to another topic.

Referring to FIG. 2 shows a limited overview of the processor 102 but, it is to be understood that other embodiment is not limited thereto. Further, the processor 102 can include any number of units communicating among each other.

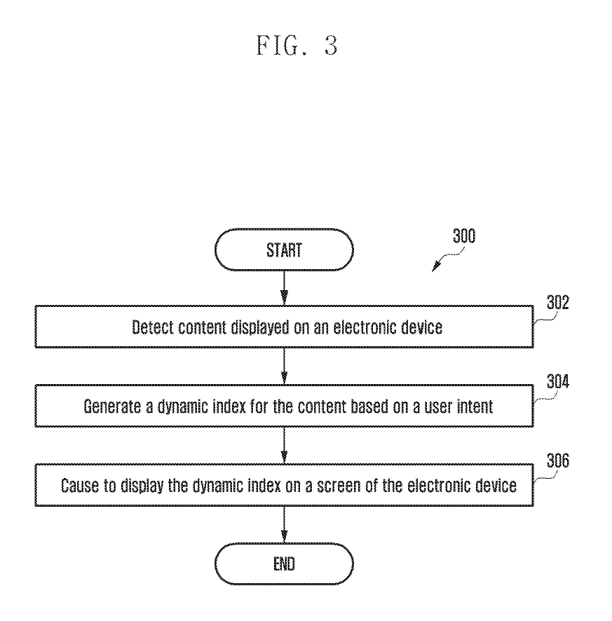

FIG. 3 is a flow diagram illustrating a method for automatically generating a dynamic index for a content displayed on an electronic device according to an embodiment of the present disclosure.

Referring to FIG. 3, at operation 302, a method 300 includes detecting the content displayed on the electronic device 100. The method 300 allows the processor 102 to detect the content displayed on the electronic device 100.

At operation 304, the method 300 includes generating the dynamic index for the content based on the user intent. The method 300 allows the processor 102 to generate the dynamic index for the content based on the user intent. In an embodiment of the present disclosure, the user intent includes the user knowledge graph, heuristics of the user reading pattern, the document type, topics of the content displayed on the electronic device 100, the state transition matrix, the user activities, or combination of same. The state transition matrix includes entries corresponding to the topics within the content, where each of the entries represents the transition probability from the current topic to the next topic.

In an embodiment of the present disclosure, the dynamic index includes the plurality of topics identified within the content, where the topics are dynamically arranged based on the user intent. The plurality of topics includes the main topic and the subtopic, where the main topic is associated with at least one of the internal content source and the optional external content source, where the sub-topic is associated with at least one of the internal content source and the optional external content source.

At operation 306, the method 300 includes causing to display the dynamic index on the display screen 104 of the electronic device 100. The method 300 allows the processor 102 to cause to display the dynamic index on the display screen 104 of the electronic device 100. In an embodiment of the present disclosure, the dynamic index is used to generate at least one of the speech grammars from topics of the dynamic index for multi-modal set, the description corresponding to the topic in the dynamic index, and cross-language terms for the topic of the dynamic index.

In an embodiment of the present disclosure, the user loads the E-book (or web page, emails, documents, and the like). After loading the E-book, the user performs a gesture to bring up a user interface (UI) displaying the dynamic index. The dynamic index includes dynamic topics within the content for the user. Each topic is based on the user intent (user interest, jump probabilities and length of the content). By clicking on one topic will auto-generate a new dynamic index based on the state transition matrix of the user, where the state transition matrix is continuously built.

Further, the topics are identifier based on heuristics dependent on the reading pattern of the user and document type, such as the e-book, the web pages, the email, and the like. The topic distribution is determined amongst the pages based on an incremental latent Dirichlet allocation (iLDA) spread. The user vector extracted via proprietary extraction process and distance computation is based on Euclidean distance between topics and the user vectors. For determining the number of topics within the content, a proprietary mechanism is used.

In an embodiment of the present disclosure, the state transition matrix is shown below in Table-1:

TABLE 1

| | T4 | T5 | T6 | T7 | T5 |
|---|---|---|---|---|---|
| T1 | 0.2 | 0.125 | 0.78 | 0.258 | 1 |
| T2 | 0.4 | 0.224 | 0.02 | 0.273 | 0 |
| T3 | 0.386 | 0.12 | 0 | 0.146 | 0 |
| T8 | 0.223 | 0.21 | 0.45 | 0.12 | 0 |
| T7 | 0.12 | 0.11 | 0.25 | 0 | 0 |

The Table-1 shows the state transition matrix for a sample of 7 topics (“T1”, “T2”, “T3”, “T4”, “T5”, “T6”, and “T7”). If the topic “T5” is selected by the user, the state transition matrix dot product with “T5” vector is made to calculate the state transition matrix for the topic “T5” (by making T5 entry 1 in 1*M matrix). The resultant state transition matrix provides the transitions for the topics based on the topic “T5”. This probability score is then used to re-compute or re-organize the topics in the dynamic links pertaining to those topics. Unlike the systems and methods of the related art, the proposed method is accurate in showing the transitions for the topics to the users. Further, the same state transition matrix can be implemented for the application jumps against particular data or data types.

In an embodiment of the present disclosure, the dynamic index is generated based on the content semantics. Initially, the user loads the page or the content (i.e., an e-book) to generate first level of index for the content. The first level of index is generated based on the user intent within the content. Based on the electronic device 100 or the server based interest extraction and topic generation service, the service will provide the calling applications with the topics of any content. The dynamic index also takes to account length of the topic (how much user usually reads). Further, if the user resumes from a previously read topic, the dynamic index is re-generated from that place onwards. The users typically have a range they read either on one or more topics. The user intent, the number of topics found, and range to be includes for the user makes each topic. In addition, the user can resume from previously read topic as it will be reconstructed from the place where the user left the reading.

In an embodiment of the present disclosure, the dynamic index is generated based on the topics clicked and accessed by the user. Based on the continuous updated transition matrix of the user, the next probable dynamic index is always displayed to the user. The user's topic jump probability within any content is calculated and kept as the state transition matrix. So, clicking on one topic will change the other topics with respect to the topic clicked and is always continuous.

In another embodiment of the present disclosure, the user can perform the swipe away gesture on the current dynamic index to display new dynamic index. The new dynamic index is generated if the user performs the swipe away gesture on the current dynamic index. The new dynamic index is based on the state transition matrix and provides new set of topics or merges previous and new topics into account if required.

In another embodiment of the present disclosure, the user is provided with an automatic bookmark for the user to resume from the place where the user left reading. The new dynamic index is generated and displayed to the user when the user resumes reading from a place where the user stopped reading from. Only the balance document is now used to re-generate the dynamic index. In an example, the user read “Sofia finds dog” and then stops after reading half-way. Next time if the user opens, the link will be “Sofia takes dog to hair-dresser” from where the user left off.

The various actions, acts, blocks, operations, and the like in the method 300 may be performed in the order presented, in a different order or simultaneously. Further, in some embodiments of the present disclosure, some of the actions, acts, blocks, operations, and the like may be omitted, added, modified, skipped, and the like without departing from the scope of the present disclosure.

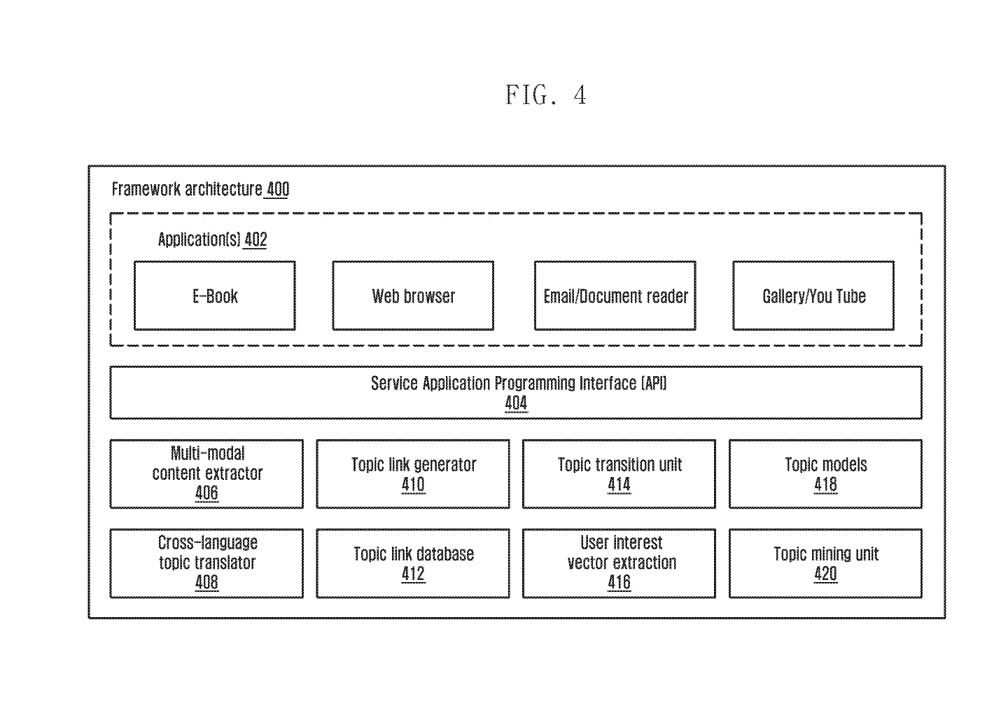

FIG. 4 illustrates a framework architecture for generating a dynamic index within a content according to the embodiments of the present disclosure.

Referring to FIG. 4, in an embodiment of the present disclosure, a framework architecture 400 includes one or more applications 402, a Service API 404, a multi-modal content extractor 406, a cross-language topic translator 408, a topic link generator 410, a topic link database 412, a topic transition unit 414, a user interest vector extraction 416, topic models 418, and a topic mining unit 420.

The topic link database 412 maintains a topic vector extracted index that describes the semantic linkages between the documents. Further, the topic link database 412 is the primary database that will be queried for linking with the external documents for the content. The service API 404 is the main interface with the framework that will be used for both querying and provisioning links from the framework. The topic models unit 418 provides a set of pre-built models that is used in determining the topics contained within the content pages and used in creating the index. The set of pre-built models are used by the topic mining unit 420 to determine the extent of topic distributions within the content used in indexing and matching. The user interest vector extraction unit 416 builds the user interest categories and also uses the topic mining unit 420 for determining the topic interests of the user. The user interest vector extracted is used in building the personalized index within the content as well as the optional external content source to link for the user. The topic transition unit 414 contains the transition matrix that is used in determining which topics or links to be set up next dependent on which link the user has clicked. The links themselves are generated by the topic link generator 410 taking inputs from the topic transition unit 414 and the topic link database 412. The cross-language translator 408 mines the topic distributions within the content in different languages and based on the similarity of topic distribution, indexes the content by providing language mappings to the topic link database 412. The multi-modal content extractor unit 406 builds speech grammars for the content provided by the one or more applications 402 that may be used by the user for navigating between the links generated.

In an embodiment of the present disclosure, multi-modal interaction allows interaction using multiple modalities, such as speech and text. In the context of bookmarks, by speaking certain commands, the users are allowed to directly go to a particular topic (or section) of the book page. There are two parts to interact with the speech, such as standard set of commands and additional keywords extracted from the text that can be spoken by the user and understood by the framework architecture 400. Further, a speech recognition (automatic speech recognizer (ASR)) unit will take a command that is spoken, converts the speech into the text and passes the recognized text on to the framework architecture 400. The fixed set of commands is pre-loaded into the ASR. Some of the commands need additional data and the ASR will wait for these fields to be filled if those commands are spoken.

In an embodiment of the present disclosure, some of the voice commands that do not require additional data (preloaded), such as Next, Bookmark, Show title, Re-compute/re-calculate index, and the like. In another embodiment of the present disclosure, the voice commands that require additional input are GOTO “some section,” and the like.

The multi-modal content extractor 406 extracts these additional inputs which can be spoken by the user. The multi-modal content extractor 406 extractor typically, in an embodiment of the present disclosure, tokenizes the title tokens that the framework architecture 400 makes to give a title to the topic (or section). The tokenized keywords can be spoken individually or as combination as a full title sentence. These keywords, once identified, are then converted to a grammar (such as a finite state grammar) that will be sent to the ASR. The manager will indicate to the ASR when to initiate listening and when to stop. The manager also indicates to the ASR when the context of the current keywords/phrases has ended.

FIG. 4 shows a limited overview of the framework architecture 400 but, it is to be understood that other embodiment is not limited thereto. Further, the framework architecture 400 can include any number of units communicating among each other.

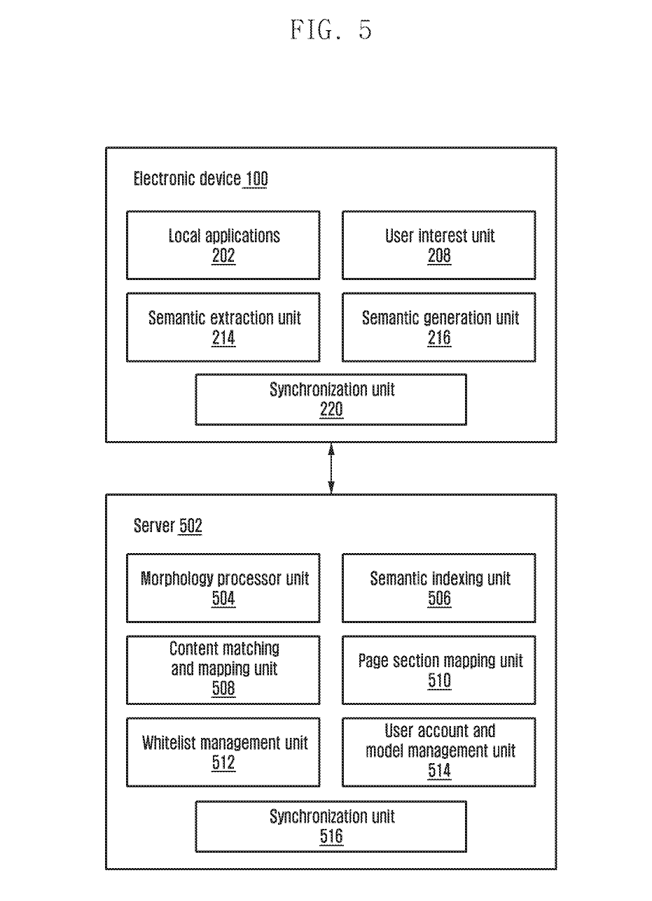

FIG. 5 illustrates a client—server architecture for automatically generating a dynamic index for a content according to an embodiment of the present disclosure.

Referring to FIG. 5, in an embodiment of the present disclosure, the client—server architecture 400 includes the electronic device 100 and a server 502. The electronic device 100 includes the local applications 202, the user interest unit 208, the semantic extraction unit 214, the semantic section generation unit 216, and the server synchronization unit 220. The functionalities of the local applications 202, the user interest unit 208, the semantic extraction unit 214, the semantic section generation unit 216, and the server synchronization unit 220 are explained in conjunction with the FIG. 2 as described above.

In an embodiment, the server 502 includes a morphology processor unit 504, a semantic indexing unit 506, a content matching and mapping unit 508, a page section mapping unit 510, a white list management unit 512, a user account and user model management unit 514, and a synchronization unit 516.

The morphology processor unit 504 performs cleanup of the content removing unwanted meta-information and transforming the text into a format that can be used by a processing unit. The semantic indexing unit 506 indexes the content through its semantics i.e., based on the topic distribution within the content. The content mapping and matching unit 508 performs the match functions between a semantic request and one found within the index. The mapping happens for cross-language content where the content in one language gets mapped to the content in another language through the semantic distributions. The page section mapping unit 510 is a granular indexing unit that maintains the page information and each section that has full or dependent semantics associated with it. This is used in index calculations and in index transitions. The white list management unit 512 determines which applications can access and use the index system and can be managed by any authorized entity. The user account and management unit 514 manages the user account, user's privacy, and security policies. The synchronizing unit 516 handles synchronizing activities between the electronic device 100 and the server 502 or between the devices.

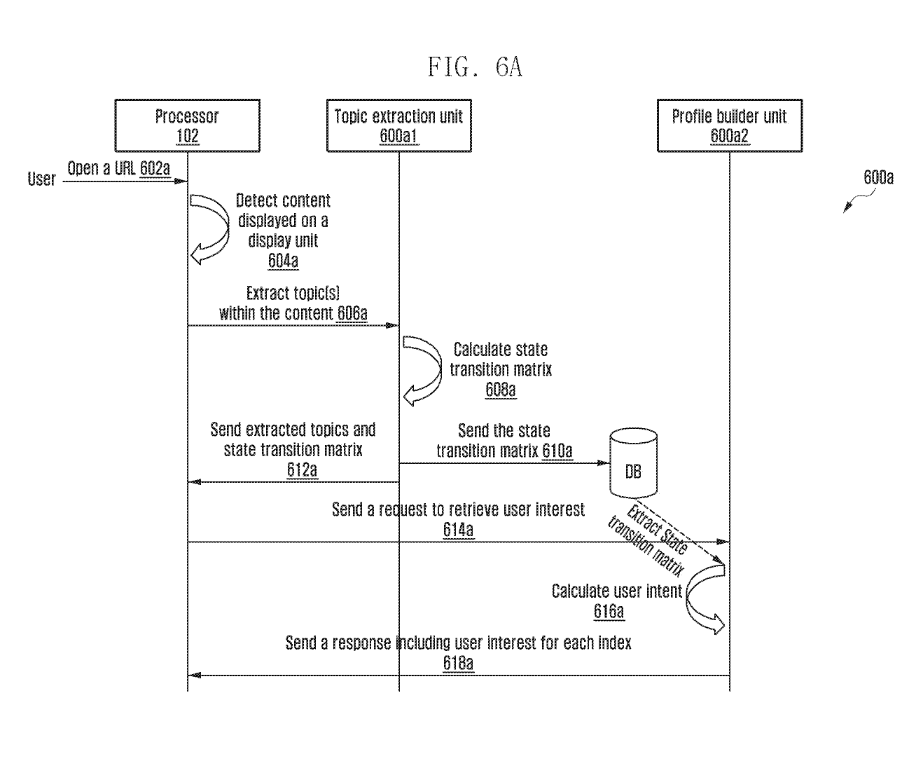

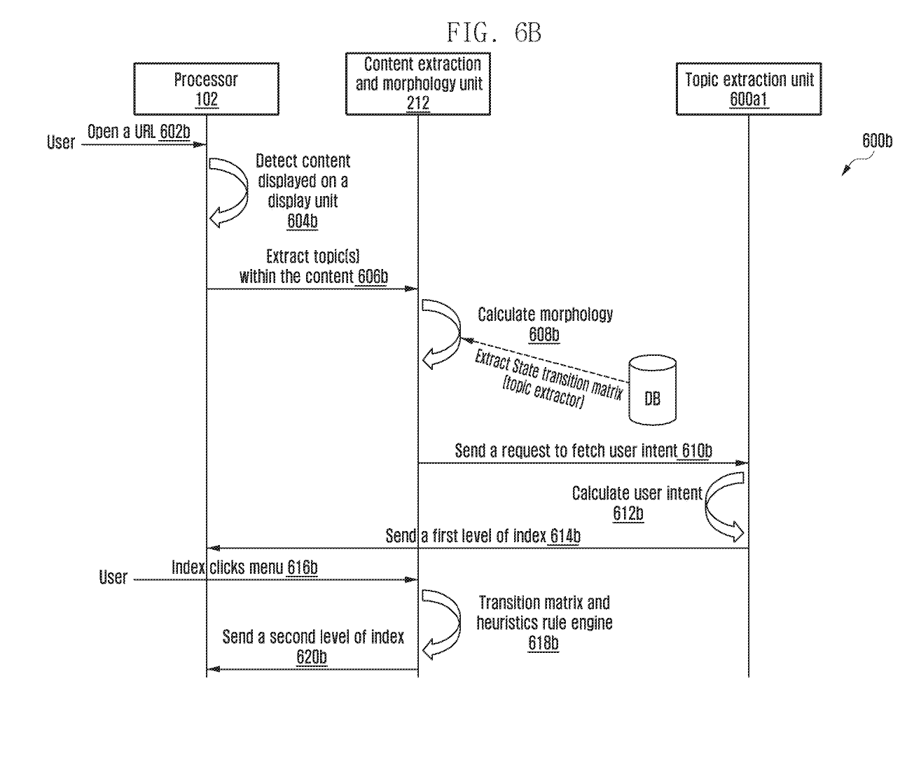

FIG. 6A is a sequence diagram for building a profile of a user and calculating user interest according to an embodiment of the present disclosure.

Referring to FIG. 6A, in an embodiment of the present disclosure, the signaling sequence depicts communication between the electronic device 100, a topic extraction unit 600a1, and a profile builder unit 600a2.

At operation 602a: Initially, the user opens a uniform resource locator (URL) on a browser. The content associated with the URL is displayed on the display screen 104 of the electronic device 100.

At operation 604a: The processor 102 detects the content displayed on the display screen 104.

At operation 606a: The topic extraction unit 600a1 extracts the topic(s) within the content displayed. In an embodiment of the present disclosure, the topic can include the main topic and the subtopic, where the main topic is associated with the internal content source, the optional external content source, or combination of same. Further, the subtopic is associated with the internal content source, the optional external content source, or combination of same.

At operation 608a: After extracting the topics, the topic extraction unit 600a1 calculates the state transition matrix. In an embodiment of the present disclosure, the state transition matrix includes entries corresponding to the topics within the content, where each of the entries represents the transition probability from the current topic to the next topic.

At operation 610a: The topic extraction unit 600a1 sends the state transition matrix to a database (DB) (i.e., the storage 106). After receiving the state transition matrix, the DB stores the state transition matrix, which is later used for automatically generating the dynamic index for the content displayed on the display screen 104.

At operation 612a: The topic extraction unit 600a1 sends the extracted topics and associated state transition matrix to the processor 102.

At operation 614a: After receiving the extracted topics and associated state transition matrix, the processor 102 sends a request to the profile builder unit 600a2 for receiving the user intent (or user interest).

At operation 616a: After receiving the request, the profile builder unit 600a2 extracts the state transition matrix from the DB. Further, based on the extracted state transition matrix, the profile builder unit 600a2 calculates the user intent. In an embodiment of the present disclosure, the user intent includes the user knowledge graph, the heuristics of the user reading pattern, the document type, the topics of the content displayed on the electronic device 100, the user activities, or combination of same.

At operation 618a: The profile builder unit 600a2 sends a response including the user intent for each index to the processor 102.

The various operations in a sequence diagram 600a may be performed in the order presented, in a different order or simultaneously. Further, in some embodiments of the present disclosure, some of the operations may be omitted, added, modified, skipped, and the like, without departing from the scope of the present disclosure.

FIG. 6B is a sequence diagram for calculating a first level index and a second level index according to an embodiment of the present disclosure.

Referring to FIG. 6B, in an embodiment of the present disclosure, the signaling sequence depicts communication between the processor 102, the content extraction and morphology unit 212, and the topic extraction unit 600a.

At operation 602b: Initially, the user opens a URL on a browser. The content associated with the URL is displayed on the display screen 104 of the electronic device 100.

At operation 604b: The processor 102 detects the content displayed on the display screen 104.

At operation 606b: The content extraction and morphology unit 212 extracts the contents and performs the morphology process.

At operation 608b: The content extraction and morphology unit 212 extracts the state transition matrix (topics) from the DB. After extracting the state transition matrix, the content extraction and morphology unit 212 calculates the morphology.

At operation 610b: The content extraction and morphology unit 212 sends a request to the topic extraction unit 600a1 for fetching the user intent.

At operation 612b: After receiving the request from the content extraction and morphology unit 212, the topic extraction unit 600a1 calculates the user intent.

At operation 614b: The topic extraction unit 600a1 sends the first level of dynamic index to the processor 102.

At operation 616b: The content extraction and morphology unit 212 receives the dynamic index clicks menu of the user.

At operation 618b: After receiving the dynamic index clicks menu, the content extraction and morphology unit 212 generates the second level of dynamic index.

At operation 620b: The content extraction and morphology unit 212 sends the second level of dynamic index to the processor 102.

The various operations in a sequence diagram 600b may be performed in the order presented, in a different order or simultaneously. Further, in some embodiments of the present disclosure, some of the operations may be omitted, added, modified, skipped, and the like, without departing from the scope of the present disclosure.

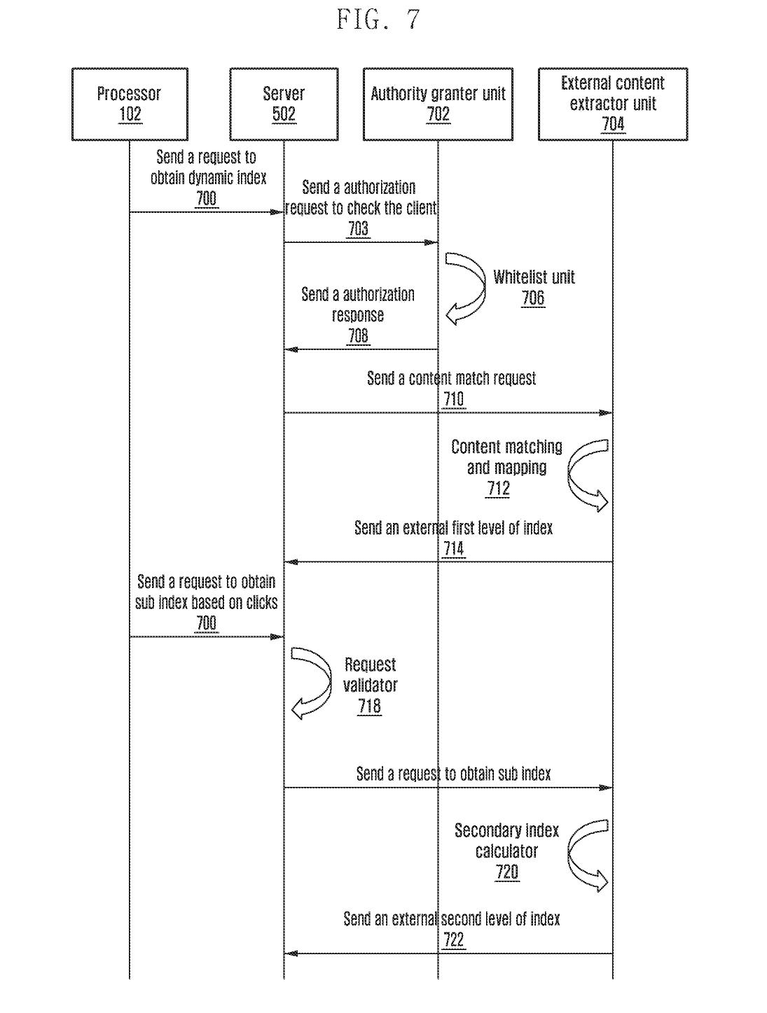

FIG. 7 is a sequence diagram for automatically generating a dynamic index for a content by a server according to an embodiment of the present disclosure.

Referring to FIG. 7, in an embodiment of the present disclosure, the signaling sequence depicts communication between the server 502, an authority granter unit 702, and an external content extractor unit 704.

At operation 700: The processor 102 can be configured to send the request to the server 502 for obtaining the dynamic index.

At operation 703: After receiving the dynamic index request, the server 502 can be configured to send an authorization request to the authority granter unit 702 to authorize the electronic device 100.

At operation 706: After receiving the authorization request, the authority granter unit 702 sends the authorization request to the white list management unit 512. The white list management unit 512 determines which applications of the electronic device 100 can access and use the index system and can be managed by any authorized entity.

At operation 708: On successful authorization, the authority granter unit 702 sends an authorization response to the server 502.

At operation 710: After receiving the authorization response, the server 502 sends the content match request to the external content extractor unit 704.

At operation 712: The external content extractor unit 704 performs the content matching and mapping by the content mapping and matching unit 508. Further, the content mapping and matching unit 508 performs the match functions between the semantic request and one found within the index. The mapping happens for cross-language content where the content in one language gets mapped to the content in another language through the semantic distributions.

At operation 714: The external content extractor unit 704 sends the external first level of dynamic index to the server 502.

At operation 716: The processor 102 sends another request to the server 502 for obtaining the sub index based on the user clicks.

At operation 718: The server 502 requests a validator by sending the request to the external content extractor 704 for obtaining the sub index.

At operation 720: The external content extractor 704 calculates the sub index.

At operation 722: The external content extractor 704 sends the sub index to the server 502.

The various operation in the sequence diagram 700 may be performed in the order presented, in a different order or simultaneously. Further, in some embodiments of the present disclosure, some of the operations may be omitted, added, modified, skipped, and the like, without departing from the scope of the present disclosure.

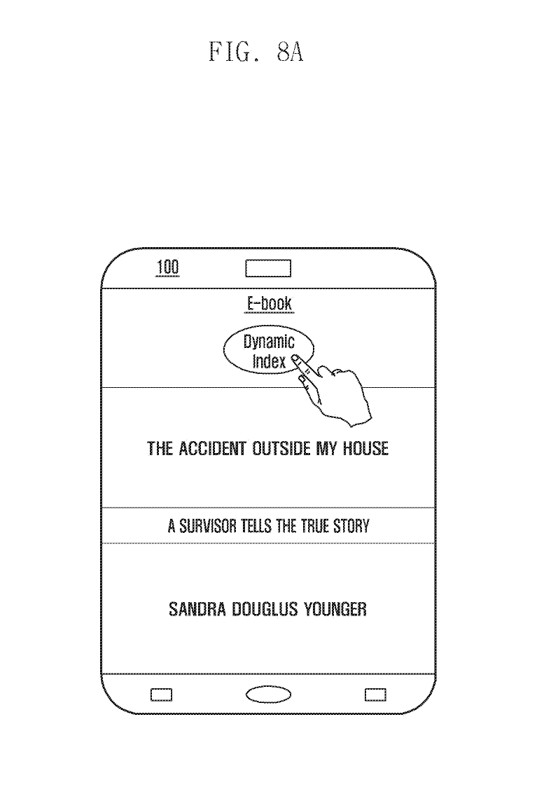

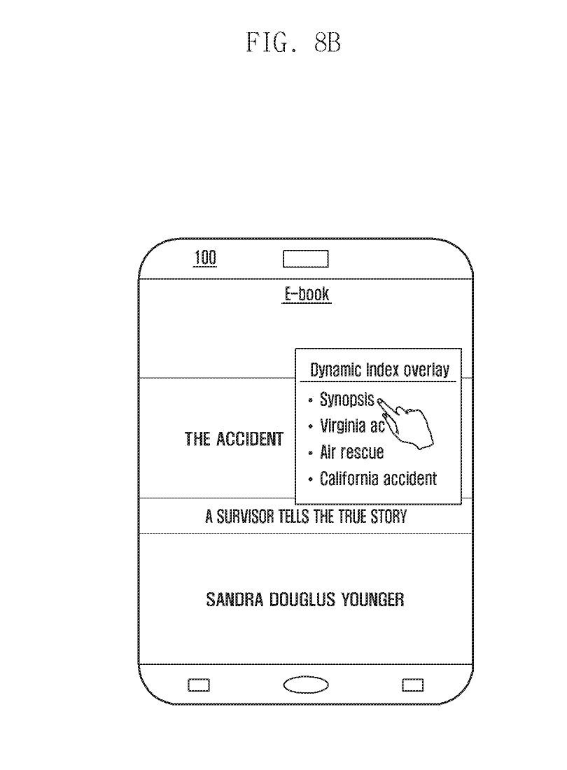

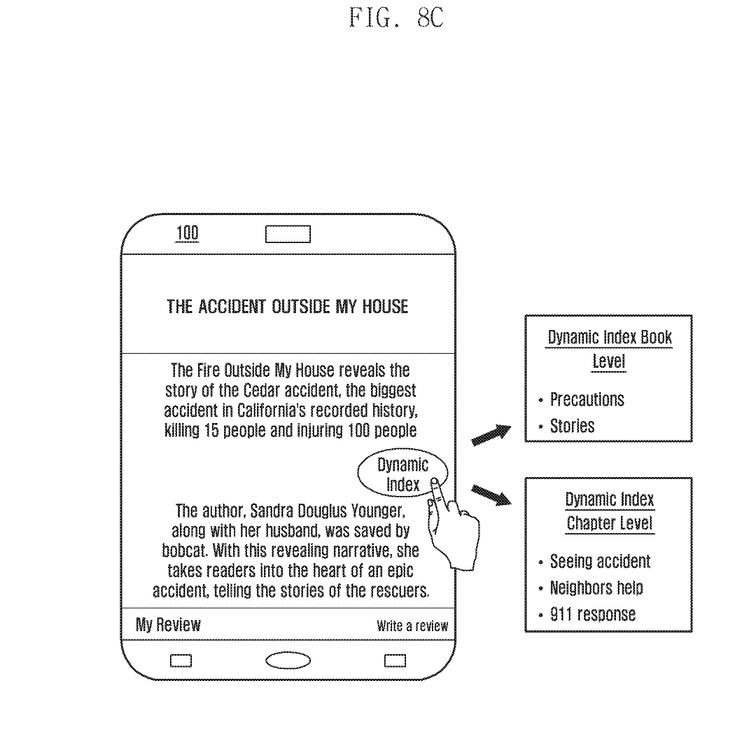

FIGS. 8A-8C illustrates an operation of generating a dynamic index for a content displayed on an electronic device according to an embodiment of the present disclosure.

Referring to FIGS. 8A to 8C, consider a scenario where the user loads the E-book (i.e., a content) including multiple pages, the set of videos, a set of images, or combination of same as shown in the FIG. 8A. After loading the E-book, the processor 102 detects the E-Book displayed on the electronic device 100. The processor 102 generates the dynamic index for the E-book based on the user intent. The user performs a gesture on the E-book displayed on the electronic device 100.

After detecting the gesture, the processor 102 brings up the UI displaying the dynamic index (i.e., an overlay of dynamic index) on the electronic device 100 to the user. The dynamic index includes the plurality of topics, such as “Synopsis”, “Virginia accident”, “Air rescue”, “California accident”, “Precautions”, and “Stories” identified within the E-book based on the user intent as shown in the FIG. 8B. The user performs the gesture on the topic “Synopsis” to read the content of the topic. After detecting the gesture, the processor 102 directly navigates and displays the topic “Synopsis” within the E-book on the electronic device 100 as shown in the FIG. 8c.

Further, as shown in the FIG. 8C, the user performs the gesture after reading the topic “Synopsis”. After detecting the gesture, the processor 102 regenerates the dynamic index and displays the “Dynamic Index-Main Book Level” and “Dynamic Index-Chapter Level”. The “Dynamic Index-Main Book Level” includes the plurality of topics, such as “Precautions”, and “Stories”. The “Dynamic Index-Chapter Level” includes the plurality of topics, such as “Seeing accident”, “Neighbors help”, and “911 response”, where the topics are arranged dynamically based on the user intent.

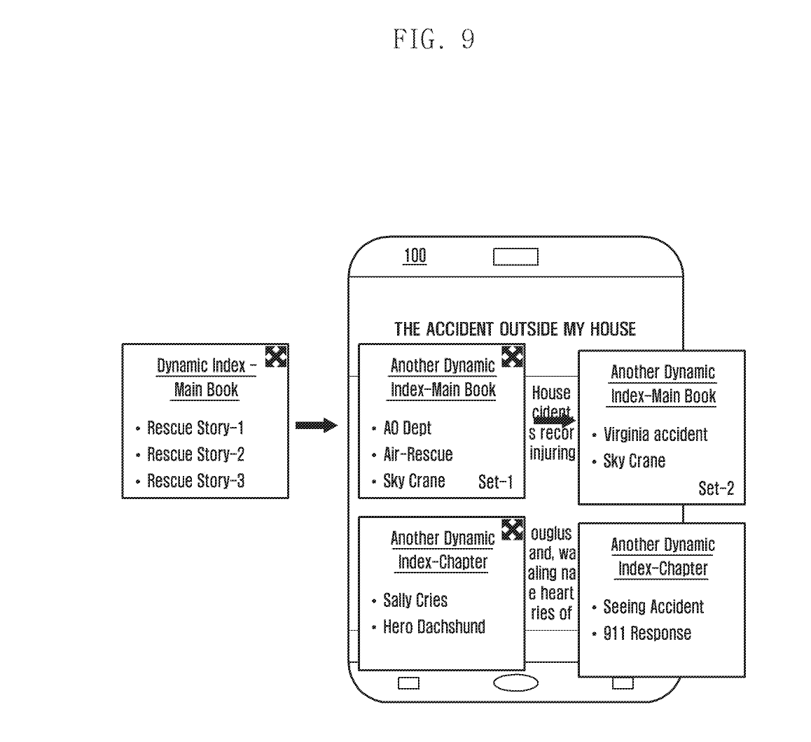

FIG. 9 illustrates an operation of displaying a next level of dynamic index based on a swipe out gesture performed by a user on a dynamic index according to an embodiment of the present disclosure. Consider a scenario where the user loads the E-book (i.e., a content) including multiple pages, the set of videos, a set of images, or combination of same. The user performs the gesture on the E-book after reading the topic “Synopsis”. After detecting the gesture, the processor 102 displays the “Dynamic Index-Main E-book index” including the plurality of topics, such as “Rescue Story-1”, “Rescue Story-2”, and “Rescue Story-3” as shown in the FIG. 9.

Referring to FIG. 9, the user performs the swipe out gesture on the “Dynamic Index-Main E-book index” to obtain another (or next) “Dynamic Index-Main E-book index” (i.e., set-1) including “AO dept.”, “Air Rescue”, and “Sky crane”. The user again perform the swipe out gesture on the another “Dynamic Index-Main E-book index” (i.e., set-1) to obtain next probable set of “Dynamic Index-Main E-book index” (i.e., set-2) including “Virginia accident” and “Sky crane” and display to the user. The set-2 is lower in probability than the set-1 which is swiped out.

Further, one or more topics are retained from the set-1 in the set-2. As shown in the FIG. 9, the “Dynamic Index-Main E-book index” (i.e., set-1) and the “Dynamic Index-Main E-book index” (i.e., set-2) have the topic “Sky crane” as the chapter link as the topic “Sky crane” has relation to other topics in both the sets. In the same way, the user can perform the swipe out gesture to obtain the dynamic index at chapter level as shown in the FIG. 9.

In an embodiment of the present disclosure, all the applications can provide the text and receive the links to the topics (or sections). The link is named according to the heuristics and the content within the topic. The link is build based on the user intent (i.e., a user browsing history, a reading pattern, a content and content length, and the like). Further, speech grammar is extracted for multimodal browser navigation.

In an embodiment of the present disclosure, the dynamic index is generated based on the user intent. Further, the dynamic index-main book and dynamic index-chapter is generated based on the topics accessed by the user within the dynamic index. The dynamic index changes in accordance to the clicks performed by the user on the dynamic index-Main book and the dynamic index-chapter. The dynamic index-chapter changes the dynamic index-Main book and vice versa.

In an embodiment of the present disclosure, the UX allows the user to swipe away the current dynamic index to bring up the alternative set. The user can close the entire suggested set altogether.

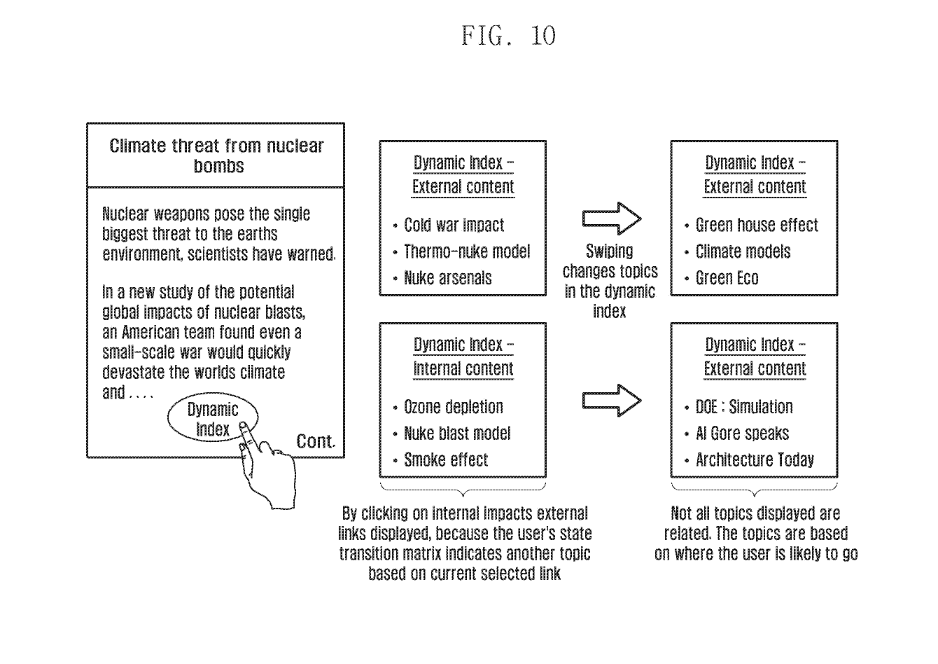

FIG. 10 illustrates an operation of displaying a dynamic index of an external content and an internal content on an electronic device according to an embodiment of the present disclosure. Consider a scenario where the user loads the web page related to “Climate threat from nuclear bombs”. The user performs the gesture on the web page to bring up the UI displaying the dynamic index including the external topics, such as “Cold war impact”, “thermo-nuke model”, and “Nuke arsenals” retrieved from one or more external sources.

Referring to FIG. 10, the user performs the swipe out gesture to change the topics in the dynamic index. After detecting the swipe out gesture, the external topics in the dynamic index which are earlier displayed to the user are changed to the topics “Green house effect”, “Climate models”, and “Green Eco”. Simultaneously, after user performs the gesture, the dynamic index including the internal topics is displayed to the user as shown in the FIG. 10. By selecting (or clicking) the internal topics, the dynamic index displayed including the external topics are impacted as the state transition matrix of the user indicates another topic based on the current selected internal topic. Based on the selected internal topic, the dynamic index including external topics, such as “DOE: Simulation”, “Al Gore speaks”, and “Architecture today” are displayed to the user as shown in the FIG. 10. All the topics displayed are not related, where the topics are displayed based on where the user is likely to visit the topics.

In an embodiment of the present disclosure, the topics from the optional external content sources dependent on the internal topics identified within the content. Further, the topics from the optional external content sources continuously changes based on either internally selected topic or externally selected topic. Further, the topics from the optional external content sources can be altered based on the swipe action performed by the user to change the topics.

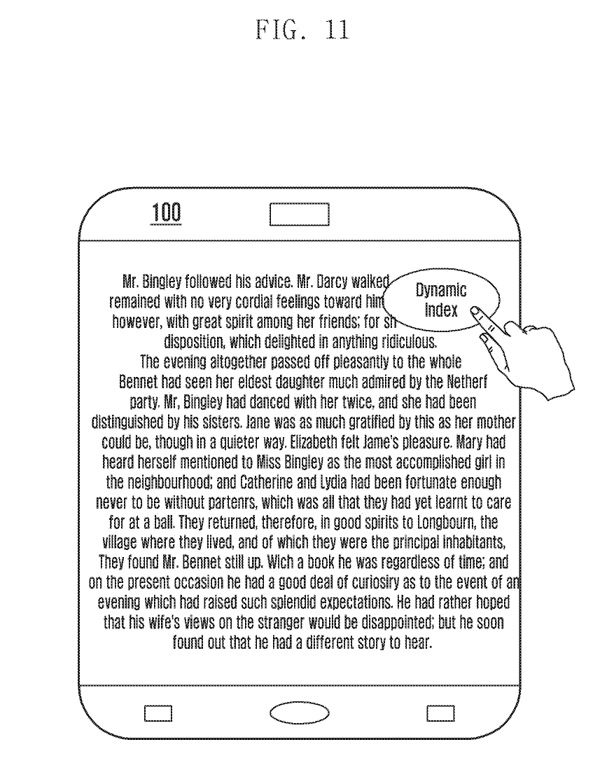

FIG. 11 illustrates an operation of automatically generating a dynamic index for a content displayed on an electronic device according to an embodiment of the present disclosure. Consider a scenario where the user loaded the E-book. The user selects the topic (or section), at a time instance “t”, “when Mr. Bingley came to Leister”. Further, at the time instance “t+K”, the user has read five pages of the topic “when Mr. Bingley came to Leister”. After reading the five pages, the user closes the E-book (or page).

Referring to FIG. 11, at the time instance “t*”, the user reopens the E-book (or page) and resumes the reading process. When the user selects (or clicks on) the “Dynamic index”, the processor 102 provides “Mr. Bingley dances with Ms Jane” as the topic. Here, the processor 102 regenerates the topics from the point where the user has left reading the E-book and provides new topics to the user. Additionally, based on the state transition matrix other topics also change. Unlike the system and methods of the related art, the proposed method provides the best divisions of the topics based on the past actions performed by the user.

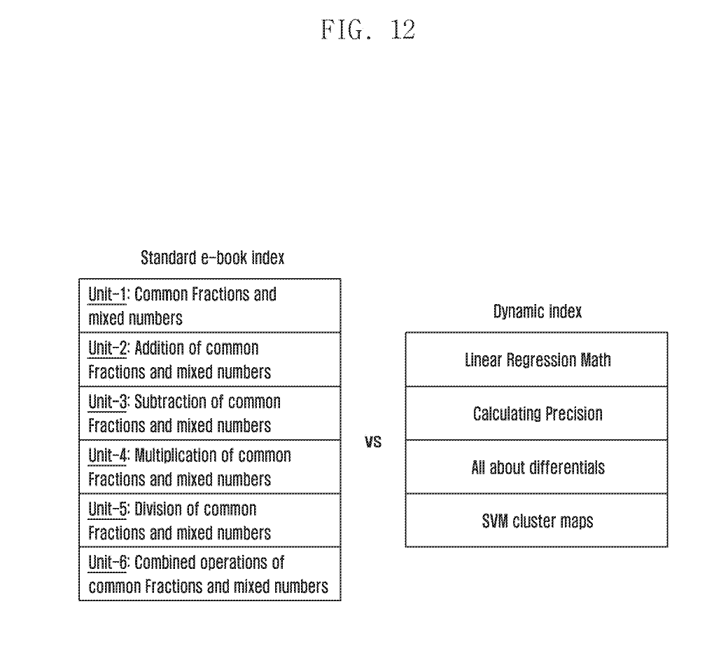

FIG. 12 illustrates a comparison between a standard index and a dynamic index according to an embodiment of the present disclosure.

Referring to FIG. 12, the E-books include the standard index which is manually segregated by author(s). These sections do not, provide specificity on the chapters and take user interests to define the links to the sections. In an example, when the user accesses the document, the links are provided to the user exactly as defined by the author. Further, as shown in the FIG. 12, the dynamic index is generated based on the user intent.

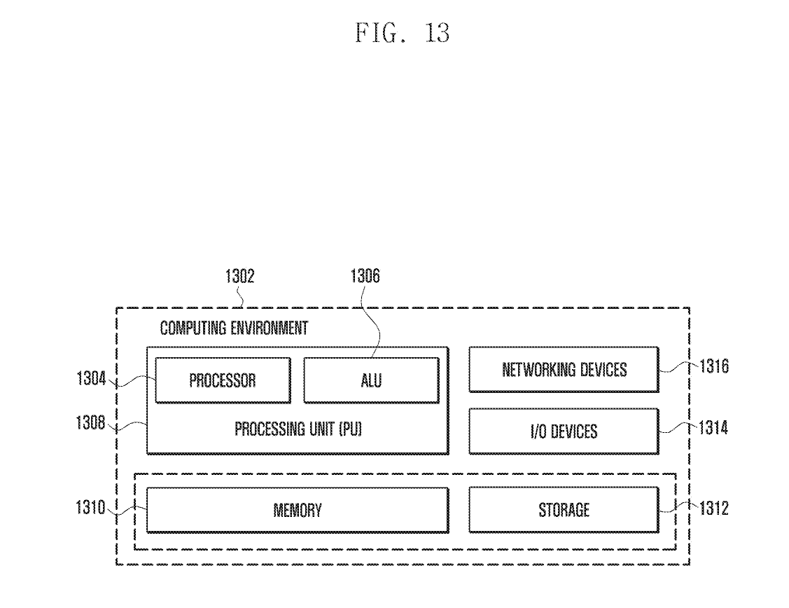

FIG. 13 illustrates a computing environment implementing a method and a system for automatically generating a dynamic index for a content displayed on an electronic device, according to embodiments of the present disclosure.

Referring to FIG. 13, a computing environment 1302 comprises at least one processing unit 1308 that is equipped with a processor 1304 and an Arithmetic Logic Unit (ALU) 1306, a memory 1310, a storage 1312, plurality of networking devices 1316 and a plurality input output (I/O) devices 1314. The processing unit 1308 is responsible for processing the instructions of the scheme. The processing unit 1308 receives commands from the processor in order to perform its processing. Further, any logical and arithmetic operations involved in the execution of the instructions are computed with the help of the ALU 1306.

The overall computing environment 1302 can include multiple homogeneous or heterogeneous cores, multiple CPUs of different kinds, special media and other accelerators. The processing unit 1308 is responsible for processing the instructions of the scheme. Further, the plurality of processing units 1308 may be located on a single chip or over multiple chips.

The scheme comprising of instructions and codes required for the implementation are stored in either the memory unit 1310 or the storage 1312 or both. At the time of execution, the instructions may be fetched from the corresponding memory 1310 or storage 1312, and executed by the processing unit 1308.

In case of any hardware implementations various networking devices 1316 or external I/O devices 1314 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 13 include blocks which can be at least one of a hardware device, or a combination of hardware device and software.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments of the present disclosure, those skilled in the art will recognize that the embodiments herein can be practiced with modification within the spirit and scope of the embodiments as described herein.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for automatically generating a dynamic index for a content displayed on an electronic device, the method comprising:
detecting the content displayed on the electronic device;
generating the dynamic index for the content based on a user intent; and
displaying the dynamic index on a screen of the electronic device.

2. The method of claim 1, wherein the user intent comprises at least of a user knowledge graph, heuristics of the user reading pattern, a document type, topics of the content displayed on the electronic device, a state transition matrix, and user activities.

3. The method of claim 2, wherein the state transition matrix comprises entries corresponding to the topics within the content, each of the entries representing a transition probability from a current topic to a next topic.

4. The method of claim 1, wherein the dynamic index comprises a plurality of topics identified within the content, the topics being dynamically arranged based on the user intent.

5. The method of claim 4, wherein the plurality of topics comprises a main topic and a subtopic, the main topic being associated with at least one of an internal content source and an external content source, the subtopic being associated with at least one of an internal content source and an external content source.

6. The method of claim 1, wherein the dynamic index is used to generate at least one of a speech grammars from topics of the dynamic index for multi-modal set, a description corresponding to a topic in the dynamic index, and cross-language terms for a topic of the dynamic index.

7. The method of claim 1, further comprising:
receiving a swipe input on a current set of the dynamic index; and
displaying, in response to receiving the swipe input, an alternative set of the dynamic index.

8. An electronic device for automatically generating a dynamic index for a content, the electronic device comprises:
a display;
a memory; and
a processor coupled to the memory, wherein the processor is configured to:
detect the content displayed on the electronic device;
generate the dynamic index for the content based on a user intent; and
cause the display to display the dynamic index on a screen of the electronic device.

9. The electronic device of claim 8, wherein the user intent comprises at least of a user knowledge graph, a heuristics of the user reading pattern, a document type, topics of the content displayed on the electronic device, a state transition matrix, and user activities.

10. The electronic device of claim 9, wherein the state transition matrix comprises entries corresponding to the topics within the content, each of the entries representing a transition probability of transition from a current topic to a next topic.

11. The electronic device of claim 8, wherein the dynamic index comprises a plurality of topics identified within the content, the topics being dynamically arranged based on the user intent.

12. The electronic device of claim 11, wherein the plurality of topics comprises a main topic and a subtopic, the main topic being associated with at least one of an internal content source and an external content source, and the subtopic being associated with at least one of an internal content source and an external content source.

13. The electronic device of claim 8, wherein the dynamic index is used to generate at least one of a speech grammar from topics of the dynamic index for multi-modal set, a description corresponding to a topic in the dynamic index, and cross-language terms for a topic of the dynamic index.

14. The electronic device of claim 8, wherein the processor is further configured to:
receive a swipe input on a current set of the dynamic index; and
cause the display to display, in response to receiving the swipe input, an alternative set of the dynamic index.

15. At least one non-transitory computer readable storage medium for storing a computer program of instructions configured to be readable by at least one processor for instructing the at least one processor to execute a computer process for performing functions of:
detecting a content displayed on an electronic device;
generating a dynamic index for the content based on a user intent; and
displaying the dynamic index on a screen of the electronic device.

16. The method of claim 6, further comprising:
performing a multi-modal interaction based on multiple modalities including a speech command and text,
wherein the speech command comprises a standard set of commands and additional keywords extracted from the text.

17. The electronic device of claim 13,
wherein the processor is further configured to perform a multi-modal interaction based on multiple modalities including a speech command and text, and
wherein the speech command comprises a standard set of commands and additional keywords extracted from the text.
